(19) United States
(12) Patent Application Publication
(10) Pub. No.: US 2019/0392484 A1
(43) Pub. Date: Dec. 26, 2019

(54) SMART METHODS AND ALGORITHMS FOR TIME-BASED VALUATION OF ONLINE SEARCH KEYWORDS

(71) Applicant: AIRBNB, INC., San Francisco, CA (US)

(72) Inventors: Tao Cui, San Francisco, CA (US); Albertus Joannis Michael Schepers, Leipzig (DE); Ye Wang, Belmont, CA (US); Trunal Bhanse, Sunnyvale, CA (US)

(73) Assignee: AIRBNB, INC., San Francisco, CA (US)

(21) Appl. No.: 16/016,293

(22) Filed: Jun. 22, 2018

(51) Int. Cl. G06Q 30/02; G06F 17/30

(52) U.S. Cl. CPC G06Q 30/0275; G06Q 30/0256; G06Q 30/0246; G06F 17/30867

(57) ABSTRACT

A lifetime value estimation of a web-based advertisement can be generated at the time of creation of a reservable listing in response to the advertisement, even when little to no information about conversion of the reservable listing is available. In a case that there is no information about a conversion time for a listing, the estimation of the lifetime value is done by calculating a real conversion rate from an advertising platform-dependent historical conversion rate, an average percentage of converted listings that converted from unreserved to reserved within a set period of days, and a scaling multiplier. Where there are relatively few conversions, the estimation of a lifetime value for the advertisement can be done using a weighted average of a campaign-level global conversion rate, which encompasses a large number of keywords that have seen conversions, and a keyword-level local conversion rate. The resulting estimated valuation, by either method, is used to submit a keyword bid to an online advertising service for display alongside a user's search results.

### BACKGROUND

Web-based services that provide search capability allow a user to search for a phrase or keyword via the Internet, and provide a sorted list of Internet-accessible results in response to the user's query. These search services may include, for example, search engines, social media websites, and/or email clients, on platforms such as Google Adwords, Facebook, Instagram, and many others. To provide these results, search services maintain a mapping or index of searchable keywords to web pages or documents, compiled through known techniques such as web crawling. A search service will, in response to a keyword-based search request by a user, consult its mapping or index to obtain and rank relevant search results, and display them to the user. Modern search services obtain revenue by displaying to the user, alongside the relevant search results, advertisements relevant to the searched-for keywords. An advertiser who wishes to place advertisements alongside search results provides the search service with a prospective advertising bid. Such a bid may include a proposed bid amount and a displayable advertisement for a particular searchable keyword.

One type of advertiser that may wish to place advertisements is online reservation systems that provide listings of properties, such as houses, condominiums, rooms, apartments, lots, and other real estate, that one user (referred to hereinafter as a “host”) may offer for reservation (sometimes referred to as a “booking” or “rental”), and another user (referred to hereinafter as a “guest”) may reserve for a specified time period (e.g., a day, week, month, or other period of interest). The online reservation system displays these reservable properties to guests as property “listings,” which contain information such as price ranges, dates, number of bedrooms, and/or other factors that may be of interest to guests in making a reservation. A higher quality listing, that is, one that presents information and/or has features that are particularly desirable to a guest, enhances a guest's experience with the reservation system and makes it more likely that the guest will book the property through the reservation system. Therefore, a higher quality listing that leads to more bookings results in a greater monetary return for the purveyor of the online reservation system, i.e., the advertiser. Different listings, with different amounts and frequency of bookings, can therefore be understood to have different numeric lifetime values (LTVs).

Listings are created by hosts based on their knowledge or interest in using an online reservation system. Because of this, an advertiser for an online reservation system may wish to place an advertisement alongside certain searchable keywords likely to attract the attention of potential hosts, and in particular, potential hosts likely to create listings with a high LTV.

Many search services assign advertising space based on keyword “auctions” or “bidding”. A commonly used method is a “second price auction” in which the highest bidder wins but the price paid is that offered by the second-highest bidder. It is commonly understood that each bidder in such an auction maximizes their expected utility by bidding their true valuation (e.g., the average LTV) of the item for sale (e.g., the keyword listing). In order to do this, the advertiser must be able to know the LTV of a particular keyword and associated advertisement.

Traditionally, advertisers submitted advertising bids blindly through “flat bidding,” based solely on industry knowledge and guesswork. It is preferable for advertisers to optimize bids for search terms where they can determine that the overhead of the bid is outweighed by the likely return (or LTV).

However, there are a number of complications to determining the LTV of a property listing. First, the period of conversion between the creation of an initial property listing and a time that the property is booked may be very long. Due to this long delay, an advertiser cannot know the time until booking of the listing at a point soon after the listing's creation, and therefore, cannot use that time until booking as a way to estimate an advertisement's LTV. Secondly, the number of conversions associated with a keyword may be very low, such that an LTV of a keyword may not be easily calculated therefrom, or, if calculable, may not be representative or reliable. Third, search services may use different and/or conflicting platforms for advertisements, or may accept different bid types from an advertiser. Because of this, an advertiser may not be able to apply the same universal evaluation to optimize bids intended to be made over different platforms.

Further techniques for improving the ability to optimize bidding for keywords on online search services are therefore generally desired.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure.

FIG. 1 is a block diagram illustrating a property listing creation system in accordance with some embodiments of the present disclosure.

FIG. 2 is a block diagram illustrating a reservation system in accordance with some embodiments of the present disclosure.

FIG. 3 is a block diagram illustrating a bidding management server in accordance with some embodiments of the present disclosure.

FIG. 4 is a flow chart illustrating an exemplary method for calculating a lifetime value of a property listing in accordance with some embodiments of the present disclosure.

FIG. 5 is a flow chart illustrating an exemplary method for calculating a lifetime value of an unconverted property listing and generating a keyword bid in accordance with some embodiments of the present disclosure.

FIG. 6 is a plot depicting a percentage of converted property listings over time in accordance with some embodiments of the present disclosure.

FIG. 7 is a flow chart illustrating an exemplary method for generating a keyword bid in accordance with some embodiments of the present disclosure.

### DETAILED DESCRIPTION

The present disclosure generally pertains to improving techniques for the optimization of online advertising (e.g., search engine marketing, social media advertising, and other online advertising platforms), and in particular, for advertisers operating a marketplace for the lease or rental of properties. In some embodiments of the present disclosure, a method is described for placing a keyword bid with a third party online advertising system, where the bid is calculated based on a lifetime value (referred to hereinafter as “LTV”, and also understood as a “long term value”) of an unreserved property listing associated with an advertisement. The LTV is the projected value (typically, a dollar value) of an item (e.g., a property listing) for a particular time horizon, or future point in time. To calculate an LTV, a system first stores multiple historical property listings that were created within a set amount of time, and for each day in that set period of time, determines which of the property listings had a reservation made on it, and determines a percentage of reservations made. This information is used, along with a historical conversion rate, to calculate a conversion rate for the unreserved property listing. An LTV for the unreserved property listing can be calculated based on that conversion rate, and that LTV can be used to generate a bid for an advertisement. Bids can be transmitted to a third-party search engine (e.g., a search engine, a social media website, or a web-based email client or mail user agent) via an API provided by that third-party or a similar tool.

In another embodiment of the present disclosure, where there are relatively few conversions, the estimation of the lifetime value can be done using a weighted average of a campaign-level global conversion rate and a keyword-level local conversion rate. An advertising campaign used in such a method encompasses a large number of keywords that have seen conversions. Accordingly, where the distribution for probability of conversion for keywords is similar for all keywords within a campaign, a weighted consideration of the campaign-level conversion rate may in some instances be applied to the calculation of a conversion rate for a particular keyword.

A logic of a bidding management system also can apply machine learning techniques to identify a plurality of historical property listings, created within a determined amount of time, that share features with a newly-created property listing. The logic is trained to identify features shared between the historical and newly-created listings that are relevant to the valuation of the listing, such as, for example, features that impact net profit, time to a first booking of the listing, timing of creation of the listing, frequency of availability of booking, among other things, that are particular to the market of the listing. Using this collection of historical property listings, the logic is then trained to compute a conversion rate for a listing, using the techniques described in the present disclosure.

It will be understood that while the present disclosure refers throughout to property listings and the lease or rental of properties through the booking of a property listing, the systems and methods described herein are not so limited. Rather, the techniques described in the present disclosure can be applied to determine the LTV of any item or service with a long conversion time or with a limited history of conversion.

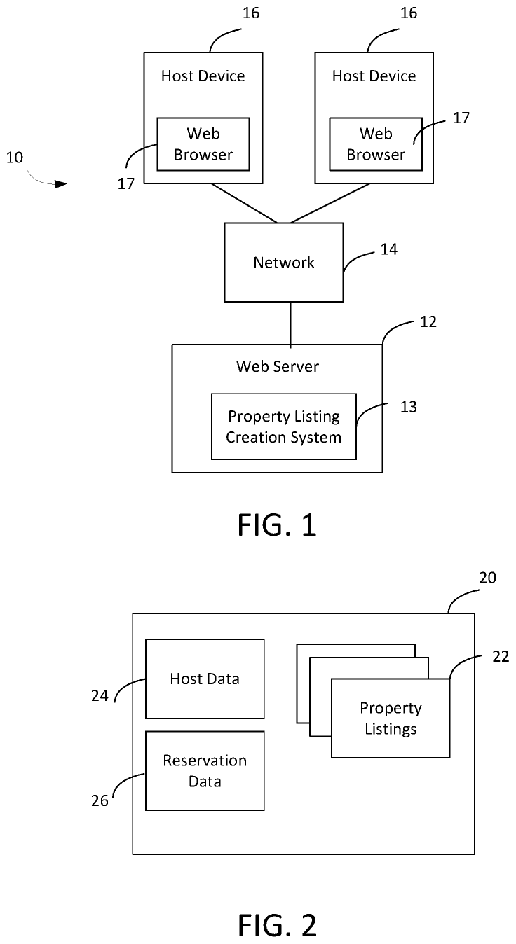

FIG. 1 depicts a property listing creation system 13 in accordance with an embodiment of the present disclosure. As shown in FIG. 1, the property listing creation system 13 may be implemented by a web server 12 or other type of device or system that is coupled to a network 14, which may comprise one or more network types, such as a local area network (LAN) or a wide area network (WAN). In some embodiments, the network 14 comprises at least the Internet, but other types of networks or combinations of networks are possible in other embodiments.

As shown by FIG. 1, a plurality of host devices 16 may be used by certain users (referred to herein as “hosts”) to create, modify, or otherwise manage property listings stored at the web server 12. Each host device 16 may be implemented by one or more computing devices, such as a desktop computer, laptop computer, or hand-held computer (e.g., a smartphone) for receiving, processing, and outputting information. As shown by FIG. 1, each host device 16 may store a web browser 17 that can be used to communicate with the web server 12 via the network 14 (e.g., the Internet). In this regard, the web server 12 may provide one or more web pages or other web content that is displayed by a host device 16 and used by a host to create and manage at least one property listing stored and processed by the property listing creation system 13. In other embodiments, the host device 16 may have a local stored application for accessing the property listing creation system 13 without the use of a generic web browser. The application also may include resources (e.g., a GUI) that allow the host to create and manage property listings by communicating with the web server 12 (e.g., adding or removing property listings, accepting or rejecting reservation requests, etc.).

Upon creation of a property listing by a user of a host device 16, the property listing creation system creates a property listing in a reservation system 20. As shown by FIG. 2, the reservation system 20 in some embodiments of the present disclosure may include a plurality of property listings 22, which may be stored in a memory of the reservation system 20. In an alternative embodiment, property listings 22 may be stored in a memory of a server separate to that which houses reservation system 20. In a preferred embodiment, a memory of the reservation system 20 may comprise a database (not specifically shown) in which the property listings 22 can be created, stored, searched, edited, manipulated, and otherwise managed. Each property listing 22 may be associated with a property (e.g., a house, condominium, room, apartment, lot, or other real estate asset) made available by a host for a guest to rent or lease. Each property listing 22 includes information about the associated property. As an example, a property listing 22 may include photographs or other images of the property, information describing physical attributes of the property (e.g., property type, number of bedrooms or bathrooms, list of amenities, location (e.g., city, state, and country), layout, and nearby attractions or activities), information describing rental attributes of the property (e.g., rental price, minimum or maximum length of stay, availability, maximum number of guests, and deposit requirements), and/or other information that may be of interest to guests in deciding whether to book a reservation for the property. In a preferred embodiment, a property listing 22 includes at minimum a property type, a property location (city, state, and country), and a number of guests that may stay on the property in connection with a reservation.

The reservation system 20 also stores, in connection with a property listing 22, information about the creation and management of the property listings 22 as host data 24 and reservation data 26. This information, which may be stored in a memory of the reservation system 20, or in a separate location, may in a preferred embodiment, include a date of the initial creation of the property listing (also referred to as a creation of an “initial listing”), and if available, the date of any update to the property listing 22 by the user of the host device 16, the date of publication of the property listing 22 such that property listing 22 is available to be booked by a guest, and the date of a “first time booked listing” (hereafter known as “FTBL”) at which time a guest actually reserves the property designated in the property listing 22.

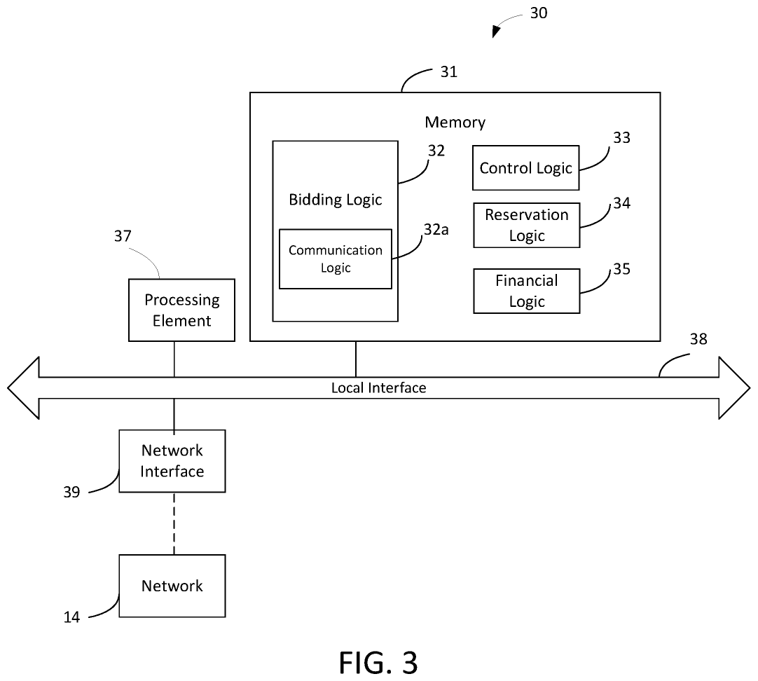

FIG. 3 depicts a bidding management server 30 in accordance with some embodiments of the present disclosure. The bidding management server 30 can include a memory 31 storing bidding logic 32 for calculating a bid for a keyword advertisement based on calculated lifetime values of one or more property listing entries in the reservation system 20, to be described further below. The bidding logic 32 may, in a preferred embodiment, include communication logic 32a for obtaining information from or communicating information to a variety of third party systems via network 14. However, in an alternative embodiment, the bidding management server 30 may include the communication logic 32a separately from the bidding logic 32. In another alternative embodiment, the communication logic 32a may communicate with third party systems and build an internally-stored advertising database containing, e.g., advertising and cost summary data. The bidding management server 30 may also include control logic 33 for generally controlling the operation of the bidding management server 30, reservation logic 34 for communicating with the reservation system 20, and financial logic 35 for communicating with a financial database (not shown) located on a separate server. In some embodiments, the bidding management server 30 may be implemented in whole or in part as a machine learning system (e.g., neural network software) for achieving the functionality described herein. In one embodiment, the bidding logic 32 may be implemented at least in part as a machine learning algorithm for determining the estimated value of a property listing with limited or no information regarding booking (conversion) of the particular property, a process described in more detail below. While, in the preferred embodiment, each of the bidding logic 32, the control logic 33, the reservation logic 34, and the financial logic 35 is depicted as part of bidding management server 30, these logical components may not be so configured, and in other embodiments, other configurations of the bidding management server 30, or distribution over several servers, are possible.

The bidding logic 32, the communication logic 32a, the control logic 33, the reservation logic 34, and the financial logic 35 can be implemented in software, hardware, firmware or any combination thereof. In the bidding management server 30 shown in FIG. 3, the bidding logic 32, the control logic 33, the communication logic 32a, the reservation logic 34, and the financial logic 35 are implemented in software and stored in memory 31 of the bidding management server 30. Note that these components, when implemented in software, can be stored and transported on any non-transitory computer-readable medium for use by or in connection with an apparatus (e.g., a microprocessor) that can execute instructions. In the context of this disclosure, a “computer-readable medium” can be any device or system that can contain or store a computer program for use by or in connection with an instruction execution apparatus.

The exemplary bidding management server 30 depicted by FIG. 3 comprises at least one conventional processing element 37, such as a central processing unit (CPU), digital signal processor, other specialized processor or combination of processors, or other circuitry that communicates to and drives the other elements within the bidding management server 30 via a local interface 38, which can include at least one bus. As an example, the processing element 37 may execute instructions of software stored in memory 31, such as the control logic 33, the bidding logic 32, the communication logic 32a, the reservation logic 34, and the financial logic 35. In some embodiments, the processing element 37 may comprise an artificial neural network or other type of configuration for performing machine learning functions based on instructions stored in memory 31. Furthermore, the bidding management server 30 may have a network interface 38 for exchanging data with the network 14 (FIG. 1).

A host device 16 creates a property listing through property listing creation system 13. In a common scenario, a user of host device 16 is driven to create the property listing through their viewing of an advertisement displayed by a web-based search service (also referred to herein as an online advertising system). These online advertising systems will generally assign a keyword-based advertisement to the highest-bidding prospective advertiser based on keyword “auctions” or “bidding.” This bidding process often takes the form of a “Second Price Auction System.” If an advertiser wins the bidding for an advertisement for a particular keyword, the third-party search services will display advertisements based on the keyword. In a preferred embodiment, the third party system will also make data available regarding the users who clicked on the advertisement. With respect to FIG. 3, the communication logic 32a uses APIs provided by those third-party search services to obtain this type of data, however, other methods of data collection may be used. This third-party data may include, for example, cost summary data comprising information about bids made for an advertisement, and click data comprising a number of user clicks made for a particular advertisement. The advertiser, through a combination of data collected through the communication logic 32a and from the reservation system 20, is therefore aware of how many users have clicked an advertisement displayed on a particular search service, how many hosts signed up with the advertiser due to such clicks, and how many property listings were created by those hosts. This information is stored so as to be accessible to bidding management server 30.

The most efficient method for bidding on a keyword is to bid the true value of the keyword to the advertiser, i.e., the lifetime value (LTV), or return on investment (ROI) that the advertiser expects if advertisements are made on the keyword. The LTV can also be described as the net profit the active listing will bring to the advertiser. However, for advertisers of a property reservation system, there are a number of complications to determining the lifetime value of a property listing. First, the period of conversion between the creation of an initial property listing and a time that the property is first booked may be very long. Booking may be further delayed if there are complications due to verification of a prospective host's eligibility and/or the overhead of upkeep and management of the property. Due to these potentially long delays, the first-time-booked-length (FTBL) of a listing may not be a known or efficient way to estimate a listing's LTV. Second, the number of conversions associated with a keyword may be very low, such that an LTV associated with a keyword that resulted in those conversions may not be easily calculated, or if calculated, may be unreliable.

As described below, the preferred embodiments described herein are directed to these complications, providing models for predicting the LTV of a newly-made property listing in two scenarios where little information is available to the advertiser: one, where the conversion time for the property is long, and two, where the conversion numbers for a keyword advertisement are low.

A. Calculating an LTV for an Unconverted Listing

In general, in a preferred embodiment of the present disclosure, the LTV of a listing can be calculated by the equation:

Initial listing LTV=FTBL LTV×Probability(initial→FTBL)

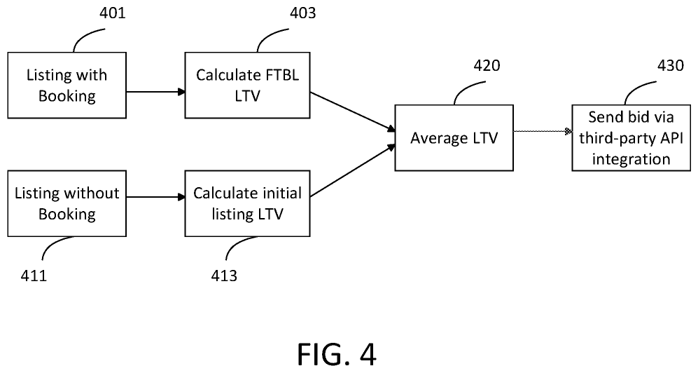

As can be seen in FIG. 4, if a listing 401 has been converted by a guest's reservation of the property, the bidding logic 32 defines a process 403 for calculating an LTV based on the actual time to booking (FTBL). In other words, it would be fairly straightforward for an advertiser to calculate a value for an existing listing that had already been converted (booked), by looking to the FTBL.

However, for an initial listing 411 that has not yet been booked, the FTBL cannot be known, and therefore, the LTV must be calculated in a different way. This is often the case for listings with a long lead time before a first booking, as described above. In the preferred embodiment, in process 413 of FIG. 4, the bidding logic 32 defines a method for calculating the LTV of an initial listing 411 by looking at, among other things, a historical conversion rate associated with properties that share characteristics and features with the initial listing. This process 413 will be described in further detail below. In process 420 of FIG. 4, the LTVs of listings with bookings and of those without bookings are averaged together to obtain an arithmetic mean. This average LTV is used as data that can be sent to a third party API of an online search service in the form of a keyword bid, as in process 430.

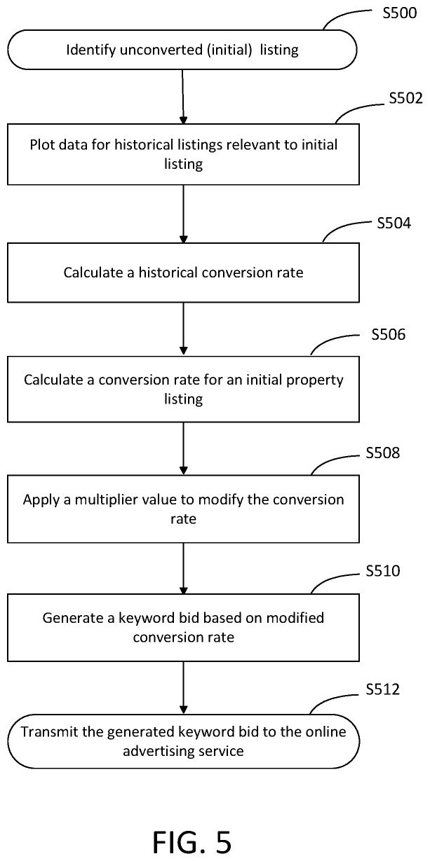

An exemplary embodiment of a method for calculating the LTV of a initial listing is illustrated in FIG. 5. All steps in FIG. 5 are performed in the exemplary embodiment by execution of the bidding logic 32, by itself or in combination with the control logic 33, the reservation logic 34, the financial logic 36, the communication logic 32a, and the network interface 39.

In step S500, the bidding logic 32 identifies an initial listing (hereafter, listing 411) that has not yet been booked. This identification is done in connection with the reservation logic 34, which pulls property listings 22 from the reservation system 20. In the preferred embodiment, the bidding logic 32 will attempt to calculate, through the steps of FIG. 5, a forward-looking window of h days in which a conversion of the listing 411 is expected to happen (also referred to as a “holdout period”).

To determine this window of h days, the bidding logic 32 in step S502, by use of the reservation logic 34, creates a graphical plot of, for each of a set of relevant historical listings that were ultimately converted (booked), the percentage of listings that were converted on each of a series of days after creation of the listings (or, in an alternate embodiment, a subset of those days). In other words, a number of days d may be plotted against a function f(d), with f(d) representing the percentage of converted listings after d days.

It will be understood that the set of relevant historical listings is selected to meet an appropriate set of factors. For example, the relevant historical listings may be limited to listings that were converted based on their advertisement on a particular search service platform (e.g., Google) that matches the search service for which the bidding logic 32 seeks to calculate a bid. As another example, the relevant historical listings may be limited to those falling within an appropriate predetermined period of time (e.g., 1 year back from the current date).

The bidding logic 32 may in one embodiment implement a machine learning algorithm to identify relevant historical data, taking into consideration features of an initial listing 411 that find similarities in historical data and that correlate to the lifetime value of a listing. For example, a machine learning algorithm may use a predictive model to identify a relevant set of data based on features such as a percentage of days the initial listing 411 is available for booking, the price of the initial listing 411, or patterns of the market of the initial listing 411, relative to comparable historical listings that have been previously booked. Of course, the features above are just taken as an example, and any algorithm may look to additional or alternate features relevant to the lifetime value of property listings.

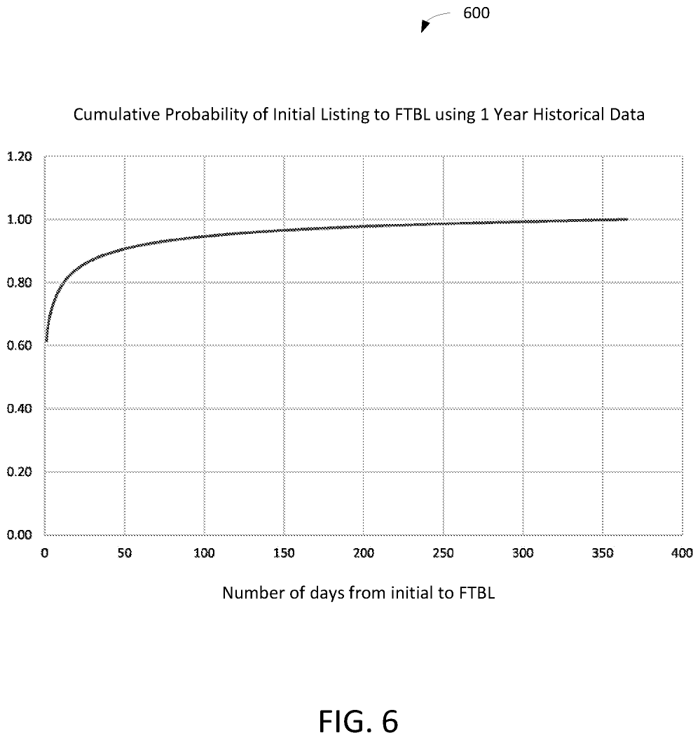

One exemplary graphical plot is illustrated in FIG. 6. The graphical plot illustrates the percentage of listings that were converted (f(d), shown on y axis) on each of a number of days (shown on x axis). It is conversely apparent that the probability that an unconverted listing can still be converted after a given number of days d is given by the equation:

1−f(d).

While FIG. 6 shows one particular example of conversion percentages, it will be understood that such a plot is wholly dependent on the relevant historical data, and FIG. 6 is not representative of a universal graphical model.

In step S504 of FIG. 5, the bidding logic calculates, according to a historical conversion rate equation, a historical conversion rate of the plotted property listings. This historical conversion rate P may be determined according to the following exemplary historical conversion rate equation:

$$\hat{r} = \frac{r \times a \times {\sum }_{i = 1}^{d} f ( i + h )}{a \times d} \qquad ( 1 )$$

where a is the number of listings created on a particular day d, h is the holdout period before conversion of a listing, f(x) is the percentage of listings converted on a day, and r is the conversion rate for the initial property listing 411 if it were available for booking for an infinite amount of days. The numerator of the historical conversion rate equation is a value of how many listings will be converted, given a period of h days. The denominator of the historical conversion rate equation is the number of listings created between d+h days ago and h days ago, a period of time totaling d days.

With reference to step S506 of FIG. 5, the historical conversion rate equation can be modified to determine an equation for calculating the real conversion rate r for the actual initial property listing 411, if said property listing were available for an infinite amount of days. This real conversion rate r may be determined by the bidding logic 32 according to the following exemplary conversion rate equation:

$$r = \frac{\hat{r}}{\frac{{\sum }_{i = 1}^{d} f ( i + h )}{d}} \qquad ( 2 )$$

The numerator of the conversion rate equation is a historical conversion rate. The denominator of the conversion rate equation is an average (arithmetic mean) of the percentage of listings that were converted between h+d days ago and h days ago (the holdout period for historical conversion rate estimation). Put another way, in the exemplary FIG. 6 shown above, the denominator is the average of all the points of the curve before the holdout window. In the example of FIG. 6, if h is 30, the average of the points of the curve before 30 (the denominator of the equation (2)) is approximately 0.95.

In step S508 of FIG. 5, the bidding logic 32 may modify the conversion rate r by a predetermined multiplier value. Data to determine the multiplier value may, in one embodiment, be accessible by the financial logic 36 from a financial server. In an exemplary embodiment, this multiplier value may have correspondence with the search service for which the bidding logic 32 is attempting to calculate a keyword bid. For example, conversions of advertisements from a particular third party platform may occur quickly, but taper off after a certain number of days (i.e., the viability or “clickability” of an advertisement burns out quickly), while conversions of advertisements from another third party platform may still be viable after that same number of days (i.e., the ads are more durable, and may still result in user conversion despite their age). As the characteristics of user conversions via particular search services (the “source” of the conversion) become known, the bidding logic 32 may maintain in memory 31 a table of known multipliers (not shown) to apply to modify LTV calculations corresponding to particular sources. As a result, the multiplier is source-dependent, and may be applied or omitted as appropriate. After application of the multiplier, by the completion of step S508, the process has computed a lifetime value (a dollar value or other currency) of an initial listing, regardless of whether a timeframe for actual conversion of the initial listing is known.

Turning to FIG. 4, in process 420, any calculated LTVs of initial unconverted listings are averaged together with known LTVs based on actual FTBLs of converted listings. This averaging is typically done as a mathematical mean of the LTV values, to result in a calculated average LTV. The bidding logic 32 thereafter creates a keyword bid based on that calculated average LTV. This keyword bid provides a highly-reliable estimation of a true value of a keyword, even if there have been no conversions resulting therefrom.

In process 430, the bidding logic 32, by use of the communication logic 32a and the network interface 39, transmits the generated bid to a remote server of an online advertising service via the network 14. As described above, this keyword bid is submitted for use in second price auctions and other common auctions managed by the online advertising service.

B. Calculating a Lifetime Value where Few Conversions Exist

There may occur a scenario where a property listing has very few conversions, for example, if there is a less desired feature to the listing, such as a less preferred location or a higher price. In such circumstances, where there may be too few conversions for historical listings to allow for the accurate and reliable calculation of an advertisement bid, an exemplary embodiment will rely upon the average mean LTV of a relevant advertising campaign. An advertising campaign (or “campaign”) is a coordinated marketing effort that comprises advertisements placed on many keywords. The resulting statistics from those keywords are evaluated under the single umbrella of the campaign. The average LTV corresponding to all the keywords in the campaign is known as the campaign mean or “global mean.”

If the number of conversions corresponding to an advertising keyword is low, the exemplary estimation of a keyword's LTV will consider a weighted average of both a campaign-level (global) conversion rate for listings and a keyword-level conversion rate (hereinafter, the mean LTV for the keyword, or a “local mean”). In another embodiment, if no keyword-level conversion is available, the global LTV can be used in place of the keyword LTV altogether. In yet another embodiment, if the number of conversions corresponding to a keyword is sufficiently high, then the local mean can be used as the estimated LTV without reference to the global mean.

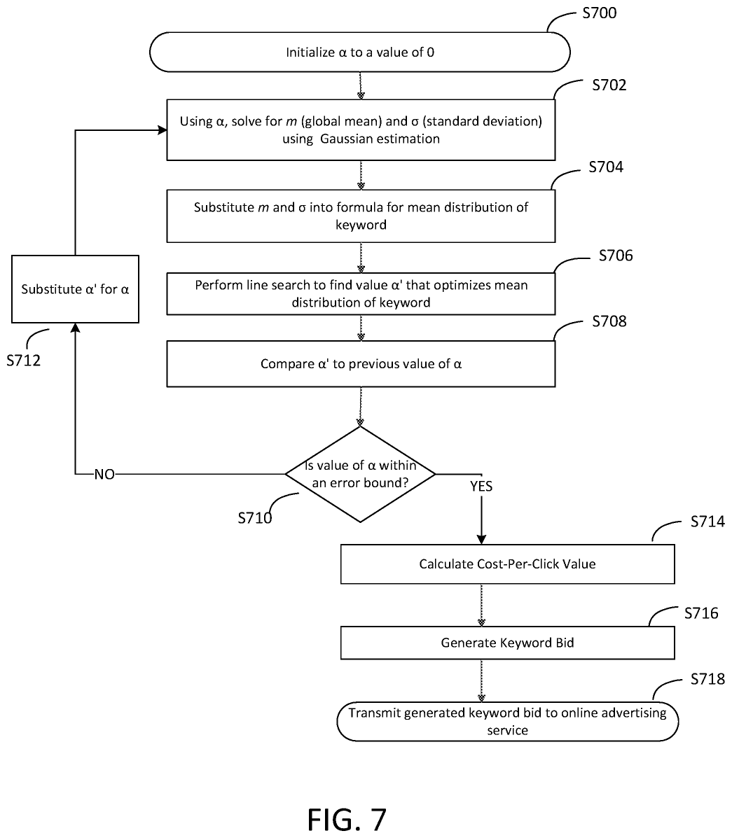

The determination of whether of the number of conversions is “sufficiently high” to allow use of the local mean is performed by the bidding logic 32 on the basis of whether the number of conversions surpasses some threshold value. In the exemplary embodiment, the bidding logic 32 can apply a formula which takes into consideration that threshold value delineating whether to estimate an LTV using the global mean or the local mean, through the process depicted in FIG. 7.

The process of estimating the LTV begins as depicted in step S700 of FIG. 7. At this step, a number of assumptions can be made about the global and local means. Initially, the local LTV of each keyword in a campaign can be understood to respectively follow a normal (Gaussian) distribution where yᵢ is a keyword conversion for the keyword i, μᵢ is the mean of distribution for the keyword i, and σ is a variance of distribution for the keyword i. Because each the plurality of keywords belongs to the same single campaign, it can be assumed that the global LTV also follows a normal distribution.

In the process shown in FIG. 7, the bidding logic 32 estimates a mean p of distribution for the keyword i (μᵢ) with reference to a global mean m and a local mean y̅. The following exemplary equation can be used to estimate μᵢ:

$${μ}_{i} = \frac{{σ}^{2} m + {n}_{i} {v}^{2} {\overline{y}}_{i}}{{σ}^{2} + {n}_{i} {v}^{2}} \qquad ( 3 )$$

where nᵢ is the number of conversions corresponding to a keyword i, σ is a variance of distribution for the keyword, and ν is a variance of distribution for the campaign. It will be understood that if there are very few conversions for a keyword i, the equation (3) will favor the global mean m. If the number of conversions for keyword i is relatively larger, the equation (3) will favor the local mean y̅.

In the preferred embodiment, equation (3) can be simplified through the use of a variable α, as follows:

$$α = \frac{{σ}^{2}}{{v}^{2}} \qquad ( 4 )$$

such that the following exemplary equation (5) is true:

$${μ}_{i} = \frac{α m + {n}_{i} {\overline{y}}_{i}}{α + {n}_{i}} \qquad ( 5 )$$

The exemplary equation represents a weighted average between the global mean and the local mean. Through an iterative analysis in steps S702 through S708 of FIG. 7, the bidding logic 32 solves for α using a maximum likelihood estimation and identifies the unknown parameters σ, m, and ν.

Turning first to initial step S700 of FIG. 7, the value α is initialized to zero (0). In a case that α is a fixed, known value, calculation of the global mean m and the global variance a can be decoupled from the equations above through a Gaussian estimation (step S702) performed by the bidding logic 32. Here, in the initial instance of step S702 where α equals 0, it is apparent from equation (5) that the global mean and global variance will reduce to a local mean and a local variance, respectively.

In step S704, the values of m and a (calculated in step S702) are substituted into formulas (4) and (5), and the value of ν can be calculated therefrom. After this substitution, the value μᵢ, as defined by equation (5), only depends on the single value of α.

In view of this dependency, the bidding logic 32 may, in step S706, use a line search approach to find a value of α that optimizes the value of μᵢ. It will be noted that a line search is itself an iterative approach to find a value of a function. The optimized value of α found by the line search is referred to hereinafter as α′.

At step S708, the bidding logic 32 compares the optimized α′ to the previous value of α. If α is not within an error bound of α′, the value of α′ is substituted for the value of α, and the process of steps S702-S708 are repeated in an additional iteration. If α is found to be within an error bound of α′, then the iterative process ends, the value of μᵢ is calculated as the LTV of the keyword based on α, m, and σ, and the process proceeds to step S714. The error bound in the preferred embodiment can be understood as any standard error bound, for example, 1 e-6.

It will be understood that because steps S702-S708 involve multiple dynamic iterative calculations, performing these calculations requires use of a computing environment with sufficient dynamic processing capability.

Next, in step S714, a cost-per-click value (hereinafter “CPC” value) can be generated in accordance with the calculated keyword LTV μᵢ. In its generation of the CPC value, the bidding logic 32 has access to three relevant pieces of information. First, the bidding logic 32 is aware of the LTV of each keyword of a campaign from its calculation in steps S702-S708. Second, the bidding logic 32, through use of reservation system 20, has access to the number of listings that were created with respect to a campaign. Third, the bidding logic 32 may use the communication logic 32a to access, from a remote third party system, external data about the number of clicks that were made for a particular keyword (i.e., the number of times a user clicked on an advertisement). Using this information, the CPC value is, in the preferred embodiment, calculated as the LTV of the keyword, multiplied by the number of listings created, and divided by the number of ad clicks, as shown in the equation below:

$$CPC = \frac{LTV \times \# listing created}{\# ad clicked} \qquad ( 6 )$$

It is noted that scenarios may occur when a host creates multiple property listings in response to a single click on a single displayed ad, and the number of listings may be greater than the number of ads clicked. The above-described method for calculating the CPC value in the preferred embodiment is very robust, and may still be used in response to such scenarios. However, it is also possible for the bidding logic 32 to take into account, as an alternative to or in addition to the method for calculating the CPC value described above, a calculated probability of an ad click and/or a calculated probability that a user creates multiple listings.

The bidding logic 32, in step S716 of the preferred embodiment, generates a keyword bid to submit to the online advertising service based on the calculated CPC value. The generation of the keyword may, in a preferred embodiment, include modifying the calculated CPC value by an efficiency target value, to further optimize advertising strategy. For example, a keyword unique to a brand owned by an advertiser would be understood to have a higher efficiency target than a keyword wholly unconnected to the advertiser. This is because a user searching for a brand-specific keyword through a search engine is more likely to have intent to use the reservation system to create and manage listings than a user searching an unrelated term.

In one embodiment, the bidding logic 32 may apply appropriate modifiers to the CPC value prior to generation of the bid, based on, for example, observations of patterns in the market in which a keyword is intended to be used, in the advertiser's campaign, or other relevant features. In another embodiment, the bidding management server 30 may contain logic that applies machine learning techniques to identify such market-driven patterns and suggests appropriate modifiers to the mathematical models described above with reference to FIG. 7.

It will be noted that the bid calculated by the embodiment depicted in FIG. 7 is platform-independent, in that it does not factor in a particular multiplier or added value specific to the platform of an online advertising system. However, it will be understood that such additional, platform-specific calculation could be performed as is appropriate by bidding logic 32.

In S718, the bidding logic 32 may, by use of the communication logic 32a and the network interface 39, transmit the generated bid to a remote server on an online advertising service (search service) via the network 14. As described above, this keyword bid is submitted for use in second price auctions and other common auctions managed by the online advertising service.

It will be apparent that by the features described above and depicted in FIGS. 3-7, an advertiser is able to estimate a value for a listing, even in a scenario where the listing has not been converted, and no realization has been seen, or where there have been little or no conversions for listings in connection with an advertisement. The efficiency of lifetime valuation of advertisements is therefore improved, with more accurately predicted return on investment. Through the invention discussed in the present disclosure, an advertiser may spend its money more efficiently, and avoid overinvesting on advertisements related to less valuable searchable keywords. The model of the present disclosure can be applied, as appropriate, on all different search service platforms and can be used for all different bid types (e.g., a value could be calculated for a payment per click, per conversion, per impression, per conversion, per listing creation, per publish, or per booking).

It has been observed that, by applying the methods described above and depicted in the drawings, there is a marked increase in realized value for a keyword bid that has been placed. In addition, the quality of new keywords can be evaluated far more quickly, and an advertiser can develop a more efficient, predictive view of the value of a keyword and/or advertising campaign.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A method for placing a keyword bid with an online advertising system based on a lifetime value (LTV) of information relating to an unreserved item in a database, the method comprising:
storing, in a table, information corresponding to a plurality of reserved items in the database, wherein each of the reserved items was created in the database within a predetermined period of time;
determining, for one or more days within the predetermined period of time, a number of reserved items for which a reservation was made on a respective day, wherein the reservation made is a first-time reservation;
calculating, based on the determining, for the one or more days, a percentage of reservations made on the plurality of reserved items on a respective day;
calculating a conversion rate for the unreserved item based on (a) a historical conversion rate of the plurality of reserved items, associated with the predetermined period of time and (b) an average cumulative value of the calculated percentages of reservations made on the plurality of reserved items on the one or more days;
calculating the LTV of the unreserved item based on the calculated conversion rate and at least one scaling multiplier, wherein the at least one scaling multiplier is determined based on a classification of the online advertising system;
generating a keyword bid in accordance with the calculated LTV; and
transmitting, to the online advertising system, the generated keyword bid.

2. The method according to claim 1, wherein the information relating to an unreserved item in a database is an unreserved property listing for a real estate property, and
wherein the plurality of reserved items are property listings for respective real estate properties that have been reserved one or more times since their creation.

3. The method according to claim 1, wherein the plurality of reserved items is selected, prior to the storing, based on an analysis of historical reserved items that have one or more features in common with the unreserved item.

4. The method according to claim 1, wherein the conversion rate is indicative of the probability of whether an unreserved item will be reserved, and
wherein the conversion rate is calculated by dividing (a) a historical conversion rate of the plurality of reserved items by (b) an arithmetic mean of the percentage of reserved items that were reserved within a predetermined number of days.

5. A method performed automatically by a computer system connected, via a network, to a remote server of an online advertising service, the method comprising:
calculating, for each keyword of a plurality of keywords associated with a marketing campaign, a lifetime value (LTV) of a keyword, the calculating including:
(a) where (i) the LTV of the keyword follows a normal distribution and (ii) μ is a mean of distribution for the keyword, σ is a variance of distribution for the keyword, m is a mean of distribution for the campaign, ν is a variance of distribution for the campaign, and
α=σ²/ν2,
initializing a value of α to 0;
(b) calculating a value of m (a mean of distribution for the campaign) and a value of σ (a variance of distribution for the keyword), in accordance with the value of α,
(c) calculating a value α′ so as to optimize the following formula:
$$µ = \frac{{a}^{′} m + ny}{{a}^{′} + n}$$
where n is number of conversions for the keyword, and y is an average LTV of the keyword,
(d) comparing the values of α and α′,
(e) setting the value of α to be equal to the value of α′,
(f) iteratively performing steps (b)-(e) until it is determined, in the comparing, that a value of α is within an error bound of α′, and
(g) when α is within the error bound of α′, calculating p as the LTV of the keyword;
determining a cost-per-click value in accordance with the calculated LTV;
generating a keyword bid in accordance with (a) the cost-per-click value and (b) a predetermined efficiency target value; and
transmitting, to the remote server of the online advertising service, the generated keyword bid.

6. The method according to claim 5, wherein the calculation of the value of m and the value of σ is done in accordance with a Gaussian estimation.

7. A system for placing a keyword bid with an online advertising system based on a lifetime value (LTV) of an unreserved property listing comprising property data, the system comprising:
a first logic for identifying, based on the property data of the unreserved property listing, a plurality of historical property listings, wherein each of the plurality of historical property listings (a) has one or more reservations, (b) comprises property data containing a value that corresponds to a value of the property data of the unreserved property listing, and (c) was created within a predetermined period of time;
a second logic for (i) calculating a historical conversion rate for the plurality of historical property listings and (ii) calculating the LTV of the unreserved property listing in accordance with the calculated historical conversion rate; and
a third logic for generating a keyword bid in accordance with the calculated LTV, and transmitting, to the online advertising system, the generated keyword bid.
